(19) United States
(12) Patent Application Publication
(10) Pub. No.: US 2004/0097687 A1
(43) Pub. Date: May 20, 2004

(54) Blocked polyisocyanates that are stable to solidification

(76) Inventors: Christoph Thiebes, Koln (DE); Hans-Josef Laas, Bergisch Gladbach (DE); Reinhard Halpaap, Odenthal (DE); Dorota Greszta-Franz, Dusseldorf (DE)

Correspondence Address: BAYER POLYMERS LLC, 100 BAYER ROAD, PITTSBURGH, PA, 15205, US

(21) Appl. No.: 10/713,812

(22) Filed: Nov. 14, 2003

(30) Foreign Application Priority Data
Nov. 18, 2002 (DE) 10253482.9

(51) Int. Cl. C08G 18/81

(52) U.S. Cl. 528/45

(57) ABSTRACT

The present invention relates to novel storage-stable blocked polyisocyanates, to a process for their preparation and to their use in the production of polyurethane materials and coatings.

### CROSS REFERENCE TO RELATED PATENT APPLICATION

The present patent application claims the right of priority under 35 U.S.C. §119 (a)-(d) of German Patent Application No.102 534 82.9, filed Nov. 18, 2002.

### FIELD OF THE INVENTION

The present invention relates to novel storage-stable blocked polyisocyanates, to a process for their preparation and to their use in the production of polyurethane materials and coatings.

### BACKGROUND OF THE INVENTION

Blocked polyisocyanates are used, for example, in one-component polyurethane stoving lacquers (1K PUR stoving lacquers), especially in the initial lacquering of motor vehicles, for the lacquering of plastics and for coil coating.

The blocking of polyisocyanates has long been known in general, inter alia for the preparation of crosslinker components for 1K polyurethane coating systems. The use of 1,2,4-triazole, diisopropylamine or malonic acid diethyl ester, for example, to block polyisocyanates results in coating systems having a particularly low crosslinking temperature. That is important from the economic point of view, and also for lacquering of heat-sensitive substrates such as plastics (“Polyurethane für Lacke und Beschichtungen”, Vincentz Verlag, Hanover, 1999).

However, organic solutions of polyisocyanates blocked with 1,2,4-triazole, diisopropylamine or malonic acid diethyl ester are not stable to storage over a period of months because they have a very high tendency to solidification, for example as a result of crystallisation of the isocyanate contained therein. That tendency is particularly pronounced for polyisocyanates having an isocyanurate structure based on linear aliphatic diisocyanates. For that reason, they are not suitable for use in solvent-borne 1K PUR coating systems, but are in some cases valuable for powder coatings.

In special cases, blocked polyisocyanates whose solutions in organic solvents do not tend to solidify, for example by crystallisation, can be obtained by the use of two or more different blocking agents (so-called mixed blocking) (see e.g. EP-A 0 600 314, EP-A 0 654 490). Compared with the use of a single blocking agent, however, mixed blocking represents an increased outlay during the preparation of the blocked polyisocyanates. In addition, the properties of the lacquers in respect of, for example, their crosslinking temperature and/or storage stability, and the properties of the coatings produced therefrom in respect of, for example, their resistance to chemicals, may be adversely affected, for which reason mixed-blocked polyisocyanates are not universally usable.

According to the teaching of DE-OS 197 38 497, blocked polyisocyanates whose organic solutions are stable to solidification by crystallisation, for example, can be obtained by reaction of mixtures of cycloaliphatic and aliphatic diisocyanates with secondary amines and subsequent partial reaction of some of the NCO groups with hydroxy-functional hydrazide compounds. Lacquer coatings produced from such polyisocyanates have a markedly different property profile than those based purely on aliphatic or cycloaliphatic diisocyanates, however, and accordingly are not universally usable.

DE-OS 100 60 327 discloses polyisocyanates that are stable to solidification, in which some of the isocyanate groups have been reacted with 3-aminopropyltrialkoxysilanes. However, they have the disadvantage that the isocyanate groups so modified are not available for a crosslinking reaction with formation of urethane groups, which can have a negative effect on coating properties, such as, for example, resistance to solvents and chemicals. In addition, such silane-modifed polyisocyanates are incompatible with certain lacquer binders.

The object of the present invention was to provide novel blocked polyisocyanates whose organic solutions are stable in the long term and which have no tendency to solidify, for example by crystallisation, even after several months.

### SUMMARY OF THE INVENTION

The present invention is directed to polyisocyanates which

A) have a mean NCO functionality ≧2,

B) have a content of blocked NCO groups (calculated as NCO, molecular weight=42) of from 2.0 to 17.0 wt. %,

C) have a content of from 1 to 30 wt. % alkoxy groups as a constituent of allophanate and, optionally, urethane groups, the molar ratio of allophanate groups to urethane groups being at least 1:9, and

D) optionally contain auxiliary substances or additives.

At least 95 mol. % of the free NCO groups are blocked with a blocking agent of the formula R¹R²NH, in which R¹ and R² are each independently of the other aliphatic or cycloaliphatic C₁-C₁₂-alkyl radicals.

The present invention is also directed to a process for preparing the above-described polyisocyanates. The process includes the steps of reacting:

a) at least one polyisocyanate having a mean NCO functionality ≧2 and an NCO content (calculated as NCO; molecular weight=42) of from 8.0 to 27.0 wt. %, with

b) at least one alcohol to form urethane groups and

c) optionally with the addition of at least one catalyst, such a proportion of the urethane groups is converted to allophanate groups that the molar ratio of allophanate groups to urethane groups is at least 1:9, and the remaining isocyanate groups, which is then reacted with

d) a blocking agent of the formula R¹R²NH, in which R¹ and R are each independently of the other aliphatic or cycloaliphatic C₁-C₁₂-alkyl radicals, so that at least 95 mol. % of the isocyanate groups are in blocked form.

The present invention is further directed to a method of making polyurethane materials and coatings that includes the step of mixing the above-described polyisocyanate with constituents for making the polyurethane materials and coatings. Additionally, the present invention is directed to substrates coated with the inventive coatings.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

It has now been found that, after blocking of the free NCO functions with secondary amines, polyisocyanates containing allophanate groups and, optionally, urethane groups are stable to storage in the form of their organic solutions and no longer have a tendency to solidify, for example by crystallisation.

The invention provides polyisocyanates which

A) have a mean NCO functionality ≧2,

B) have a content of blocked NCO groups (calculated as NCO, molecular weight=42) of from 2.0 to 17.0 wt. %,

C) have a content of from 1 to 30 wt. % alkoxy groups as a constituent of allophanate and, optionally, urethane groups, the molar ratio of allophanate groups to urethane groups being at least 1:9, and

D) optionally contain auxiliary substances or additives,

characterised in that at least 95 mol. % of the free NCO groups are blocked with a blocking agent of the formula R₁R²NH, in which R¹ and R² are each independently of the other aliphatic or cycloaliphatic C₁-C₁₂-alkyl radicals.

The invention also provides a process for the preparation of the polyisocyanates according to the invention, in which

a) at least one polyisocyanate having a mean NCO functionality ≧2 and an NCO content (calculated as NCO; molecular weight=42) of from 8.0 to 27.0 wt. % is reacted with

b) at least one alcohol to form urethane groups and

c) optionally with the addition of at least one catalyst, such a proportion of the urethane groups is converted to allophanate groups that the molar ratio of allophanate groups to urethane groups is at least 1:9, and the remaining isocyanate groups are then reacted with

d) a blocking agent so that at least 95 mol. % of the isocyanate groups are in blocked form.

There may be used as the polyisocyanate a), individually or in any desired mixtures with one another, any polyisocyanates that are based on aliphatic, cycloaliphatic, araliphatic and/or aromatic diisocyanates and contain uretdione, isocyanurate, allophanate, biuret, iminooxadiazinedione and/or oxadiazinetrione groups, but the use of di- and poly-isocyanates that contain solely aliphatically and/or cycloaliphatically bonded isocyanate groups is preferred.

The following may be mentioned as examples of suitable diisocyanates: 1,4-diisocyanatobutane, 1,6-diisocyanatohexane (HDI), 2-methyl-1,5-diisocyanato-pentane, 1,5-diisocyanato-2,2-dimethylpentane, 2,2,4- and 2,4,4-trimethyl-1,6-diisocyanatohexane, 1,10-diisocyanatodecane, 1,3- and 1,4-diisocyanatocyclo-hexane, 1,3- and 1,4-bis-(isocyanatomethyl)-cyclohexane, 1-isocyanato-3,3,5-trimethyl-5-isocyanatomethylcyclohexane (isophorone diisocyanate, IPDI), 4,4′-diisocyanatodicyclohexylmethane, 1-isocyanato-1-methyl-4(3)isocyanato-methyl-cyclohexane (IMCI), bis-(isocyanatomethyl)-norbomane, 1,3- and 1,4-bis-(2-isocyanato-prop-2-yl)-benzene (TMXDI), 2,4- and 2,6-diisocyanatotoluene (TDI), 1,5-diisocyanatonaphthalene.

Special preference is given to polyisocyanates a) having an isocyanurate, iminooxadiazinedione or biuret structure based on hexamethylene diisocyanate (HDI), isophorone diisocyanate (IPDI) and/or 4,4′-diisocyanatodicyclohexyl-methane or mixtures of those compounds.

Very special preference is given to polyisocyanates a) having an isocyanurate structure and/or iminooxadiazinedione structure based on hexamethylene diisocyanate (HDI).

There may be used as the alcohol b) any saturated or unsaturated alcohol having a linear or branched structure, as well as cycloaliphatic alcohols individually or in any desired mixture with one another.

Preference is given to such alcohols having up to 36, especially up to 23, carbon atoms.

Examples are monoalcohols, such as methanol, ethanol, n-propanol, isopropanol, n-butanol, isobutanol, tert.-butanol, n-pentanol, 2-hydroxypentane, 3-hydroxypentane, the isomeric methyl butyl alcohols, the isomeric dimethyl propyl alcohols, n-hexanol, n-heptanol, n-octanol, n-nonanol, 2-ethylhexanol, trimethylhexanol, cyclohexanol benzyl alcohol, n-decanol, n-undecanol, n-dodecanol (lauryl alcohol), n-tetradecanol, n-pentadecanol, n-hexadecanol, n-heptadecanol, n-octadecanol (stearyl alcohol), 2,6,8-trimethylnonanol, 2-tert.-butylcyclohexanol, 5-cyclohexyl-1-butanol, 2,4,6-trimethyl benzyl alcohol, cyclohexanol, cyclopentanol, cycloheptanol and the substituted derivatives thereof. Also suitable are linear or branched primary fatty alcohols of the type marketed, for example, by Henkel KGAA, Düsseldorf, under the trade name Lorol®.

There may additionally be used as alcohols also diols and/or higher-functional alcohols, which in some cases have n to 36, and in other cases n to 23, carbon atoms (where n=OH functionality of the alcohol). Examples of such di- or higher-functional alcohols are 1,2-ethanediol, 1,2- and 1,3-propanediol, 1,2- and 1,4-cyclohexanediol, 1,2- and 1,4-cyclohexanedimethanol, 4,4′-(1-methylethylidene)-biscyclohexanol, the isomeric butane-, pentane-, hexane- and heptane-, nonane-, decane- and undecane-diols, 1,12-dodecanediol, as well as higher-functional alcohols, such as, for example, 1,2,3-propanetriol, 1,1,1-trimethylolethane, 1,2,6-hexanetriol, 1,1,1-trimethylolpropane, 2,2-bis(hydroxymethyl)-1,3-propanediol or 1,3,5-tris(2-hydroxyethyl)isocyanurate.

Alcohols which are also suitable, although less preferred, are those which carry, in addition to hydroxyl groups, also further functional groups that are not reactive towards isocyanate groups, such as, for example, ester groups, ether oxygen, and/or which contain further hetero atoms, such as, for example, halogen atoms, silicon, nitrogen or sulfur.

Saturated monoalcohols having from 4 to 23 carbon atoms are very particularly preferred.

In the process according to the invention, the starting components a) and b) are reacted with one another at temperatures of from 40 to 180° C., in some cases from 50 to 150° C., and in other cases from 75 to 120° C., in a NCO/OH equivalent ratio of from 2:1 to 80:1, in some cases from 3:1 to 50:1, and in other cases from 6:1 to 25:1, optionally in the presence of a catalyst c), in such a manner that urethane groups formed as the primary product by NCO/OH reaction react further to allophanate groups, the molar ratio of allophanate groups to urethane groups in the polyisocyanate (end product) prepared according to the invention being at least 1:9, in some cases at least 3:7, and in other cases especially at least 9:1.

It is preferred to use a catalyst c) for the allophanate-forming reaction. Suitable catalysts are any compounds known in the prior art, individually or in any desired mixtures with one another, such as, for example, metal salts, metal carboxylates, metal chelates or tertiary amines (GB-PS 994 890), alkylating agents (U.S. Pat. No. 3,769,318) or strong acids (EP-A 000 194).

Preference is given to

zinc compounds, such as, for example, zinc(II) stearate, zinc(II) n-octanoate, zinc(II) 2-ethyl-1-hexanoate, zinc(II) naphthenate, zinc(II) acetylacetonate,

tin compounds, such as, for example, tin(II) n-octanoate, tin(II) 2-ethyl-1-hexanoate, tin(II) laurate, dibutyltin oxide, dibutyltin dichloride, dibutyltin diacetate, dibutyltin dilaurate, dibutyltin dimaleate, dioctyltin diacetate, or aluminium tri(ethylacetoacetate), iron(III) chloride, potassium octoate, bismuth, manganese, cobalt or nickel compounds, as well as strong acids, such as, for example, trifluoroacetic acid, sulfuric acid, hydrochloric acid, hydrobromic acid, phosphoric acid or perchloric acid, or any desired mixtures of such catalysts.

Zinc(II) compounds and/or bismuth(III) compounds of the above-mentioned type are to be used in particular.

Zinc(II) n-octanoate, zinc(II) 2-ethyl-1-hexanoate and/or zinc(II) stearate and/or bismuth(II) 2-ethyl-1-hexanoate are very particularly preferred.

Suitable, although less preferred compounds are also those which, according to the teaching of EP-A 649 866, catalyse both the allophanate-forming reaction and the trimerisation of isocyanate groups with the formation of isocyanurate structures.

The amount of the catalyst c) that is optionally to be used is from 0.001 to 5 wt. %, in some cases from 0.005 to 1 wt. %, based on the total weight of the reactants a) and b).

Addition to the reaction mixture may be carried out by any desired method. For example, it is possible to mix the catalyst that is optionally to be used concomitantly with either component a) and/or component b) before the beginning of the actual reaction. It is also possible to add the catalyst to the reaction mixture at any desired point in time during the urethanisation reaction or alternatively, within the scope of a two-step reaction, following the urethanisation, that is to say when the urethane-NCO content theoretically corresponding to complete conversion of isocyanate groups and hydroxyl groups has been reached. Likewise, it is possible first to react one or more constituents of component a) with the alcohol b) within the scope of a urethanisation reaction and then, that is to say when the NCO content theoretically corresponding to complete conversion of isocyanate groups and hydroxyl groups has been reached, to add the catalyst together with the remaining constituents of component a).

The progress of the conversion to allophanate can be monitored in the process according to the invention by, for example, titrimetric determination of the NCO content. When the desired NCO content has been reached, in some cases when the molar ratio of allophanate groups to urethane groups in the reaction mixture is at least 1:9, in the cases at least 3:7, and in some situations at least 9:1, the reaction is terminated. In cases where the reaction is carried out purely thermally, this can be effected, for example, by cooling the reaction mixture to room temperature.

When an allophanate-formation catalyst of the mentioned type is used concomitantly, as is preferred, the reaction can be stopped by the addition of suitable catalytic poisons, for example acids such as dibutyl phosphate or acid chlorides such as benzoyl chloride or isophthaloyl dichloride. However, it is not absolutely necessary in the process according to the invention to stop the reaction.

Following the allophanate-forming reaction, reaction with the blocking agent d) is carried out to form the blocked polyisocyanates according to the invention.

There is used as the blocking agent d) a secondary amine of the formula R R²NH, in which R¹ and R² are each independently of the other aliphatic or cycloaliphatic C₁-C₁₂-alkyl radicals.

Preference is given to secondary amines in which R¹ and R² are each independently of the other aliphatic or cycloaliphatic C₁-C₄-alkyl radicals, especially wherein R¹=R².

Diisopropylamine and dicyclohexylamine, especially diisopropylamine, are particularly preferred.

The blocking reaction is carried out by methods known to the person skilled in the art by direct reaction of the NCO groups with the blocking agent d) in a molar ratio of from 0.95 to 1.5, in some cases from 0.98 to 1.05, and in other cases 1:1, or optionally, but not preferably, in the presence of catalysts known per se in polyurethanes chemistry for NCO blocking.

It is possible, although less preferred, to react some of the NCO groups that are present with the blocking agent d) before the end of the urethanisation or allophanate-forming reaction. Independently of the procedure, at least 95 mol. %, in some cases at least 98 mol. %, and in other cases at least 99.5 mol. %, of the NCO groups in the polyisocyanates according to the invention are in blocked form.

The process according to the invention may optionally be carried out in a suitable solvent that is inert towards isocyanate groups. Suitable solvents are, for example, the conventional lacquer solvents, such as, for example, ethyl acetate, butyl acetate, 1-methoxypropyl 2-acetate, 3-methoxy n-butylacetate, acetone, 2-butanone, 4-methyl-2-pentanone, cyclohexanone, toluene, xylene, N-methyl-pyrrolidone, chlorobenzene. Also suitable are mixtures which contain especially higher substituted aromatic compounds such as are available commercially, for example, under the names Solvent Naphtha, Solvesso® (Exxon Chemicals, Houston, USA), Cypar® (Shell Chemicals, Eschbom, DE), Cyclo Sol® (Shell Chemicals, Eschbom, DE), Tolu Sol® (Shell Chemicals, Eschbom, DE), Shellsol® (Shell Chemicals, Eschbom, DE). The addition of solvents may, however, also be carried out following the preparation of the blocked polyisocyanates according to the invention, for example in order to reduce the viscosity. In that case, alcohols, such as, for example, isobutyl alcohol, may also be used, because the NCO groups that are present have then reacted completely with the isocyanate-reactive groups of components b) and c).

Preferred solvents are acetone, butyl acetate, 2-butanone, 1-methoxypropyl 2-acetate, xylene, toluene, isobutyl alcohol, mixtures containing especially higher substituted aromatic compounds such as are available commercially under the names Solvent Naphtha, Solvesso® (Exxon Chemicals, Houston, USA), Cypar® (Shell Chemicals, Eschborn, DE), Cyclo Sole (Shell Chemicals, Eschborn, DE), Tolu Sole (Shell Chemicals, Eschbom, DE), Shellsol® (Shell Chemicals, Eschbom, DE).

The content of covalently bonded alkoxy groups is to be defined as follows (formula [1]):

$$\begin{matrix}Content of covalently \\ bonded alkoxy groups\end{matrix} = \frac{Weight of alcohols [ g ]}{\begin{matrix}Weight of polyisocyanates [ g ] + weight of alcohols [ g ] + \\ weight of catalysts [ g ]\end{matrix}} \qquad [ 1 ]$$

The data given relating to the NCO functionality of the process products according to the invention relate to the value which can be calculated from the type and functionality of the starting components according to formula [2]

$$F = \frac{\sum equiv . NCO - \sum ( 1 + x ) \cdot equiv . OH}{\sum ( \frac{equiv . NCO}{{f}_{NCO}} ) + \sum ( \frac{equiv . OH}{{f}_{OH}} ) - \sum ( 1 + x ) \cdot equiv . OH} \qquad [ 2 ]$$

in which x with 1≧x≧0 represents the proportion of urethane groups converted to allophanate groups in the process according to the invention and can be calculated from the NCO content of the products. The functionality f_{NCO} of the starting polyisocyanates a) can be calculated from the NCO content and the molecular weight determined, for example, by gel permeation chromatography (GPC) or vapour-pressure osmosis. According to the invention, x must comply with the following restriction: 1≧x≧0.1.

Otherwise, the components a) to d) used in the preparation of the polyisocyanates according to the invention are employed in such a type and amount that the resulting polyisocyanates correspond to the statements given above under A) to D), wherein

A) the mean NCO functionality can be from 2.3 to 9.9, in some cases from 2.8 to 6.0, and in other cases from 3.3 to 5.2,

B) the content of blocked and free NCO groups (calculated as NCO, molecular weight=42) can be from 2.0 to 17.0 wt. %, in some cases from 6.0 to 16.0 wt. %,

C) the content of alkoxy groups can be from 1.0 to 30.0 wt. %, in some cases from 3 to 16 wt. %, and in other cases from 4 to 13 wt. %, and the molar ratio of allophanate groups to urethane groups can be at least 1:9, in some cases at least 3:7, and in other cases at least 9:1.

Auxiliary substances or additives D) which are optionally present may be, for example, antioxidants such as 2,6-di-tert.-butyl-4-methylphenol, UV absorbers of the 2-hydroxyphenyl-benzotriazole type, or light stabilisers of the type of the HALS compounds substituted or unsubstituted at the nitrogen atom, such as Tinuvin® 292 and Tinuvin® 770 DF (Ciba Spezialitaten GmbH, Lampertheim, DE) or other commercially available stabilising agents, as are described, for example, in “Stabilization of Polymeric Materials” (H. Zweifel, Springer Verlag, Berlin, 1997, Appendix 3, p. 181-213), or any desired mixtures of those compounds. Stabilisers containing hydrazide groups and/or hydroxy-functional stabilisers, such as the addition product of hydrazine with propylene carbonate described in EP 0 829.500, may also be used.

The compositions according to the invention can be used as a constituent in lacquers or in the production of polyurethane materials. In particular, they can be used as crosslinker component in 1K stoving lacquers, especially for the lacquering of plastics, the initial lacquering of motor vehicles or for coil coating.

For the production of 1K stoving lacquers, the polyisocyanates according to the invention are mixed with lacquer binders known in lacquer technology, optionally with the admixture of further constituents, solvents and other auxiliary substances and additives, such as plasticisers, flow improvers, pigments, fillers, or catalysts that accelerate the crosslinking reaction. Care must be taken to ensure that mixing is carried out below the temperature at which the blocked NCO groups are able to react with the other constituents. Mixing preferably takes place at temperatures of from 15 to 100° C.

The compounds used in the 1K stoving lacquers as lacquer binders for cross-linking with the compositions according to the invention contain on average per molecule at least two groups that are reactive towards NCO groups, such as, for example, hydroxyl, mercapto, optionally substituted amino or carboxylic acid groups.

The lacquer binders used are preferably di- and poly-hydroxyl compounds, such as, for example, polyester polyols and/or polyether polyols and/or polyacrylate polyols. The 1K polyurethane lacquers obtained in conjunction with diols and polyols are suitable especially for the production of high-quality coatings.

The equivalent ratio of blocked and unblocked NCO groups to NCO-reactive groups can be from 0.5 to 2, in some cases from 0.8 to 1.2; in certain situations the ratio is 1.

Further compounds that are reactive with NCO-reactive groups may optionally be used as an additional crosslinking component in conjunction with the compositions according to the invention. Such compounds are, for example, compounds containing epoxy groups, and/or aminoplastic resins. Aminoplastic resins are to be regarded as being the condensation products of melamine and formaldehyde or of urea and formaldehyde known in lacquer technology. There are suitable, for example, any conventional melamine-formaldehyde condensation products that are not etherified or are etherified by saturated monoalcohols having from 1 to 4 carbon atoms. In the case of the concomitant use of other crosslinker components, the amount of binder having NCO-reactive groups must be adapted accordingly.

The preferred use is in solvent-bome lacquers. Of course, use in aqueous lacquers or, although less preferred, in powder coatings is also possible.

Such lacquers can be used for the coating of various substrates, especially for the coating of metals, wood and plastics. The substrates may already be coated with other lacquer layers, so that a further lacquer layer is applied by coating with the lacquer containing the composition according to the invention.

The advantages achieved with the polyisocyanates according to the invention consist in a marked improvement in storage stability in organic solvents, especially in respect of crystallisation and solidification of the blocked polyisocyanates and of the 1K polyurethane lacquers formulated therewith. Furthermore, the coatings obtained using the polyisocyanates according to the invention in some cases cure fully at lower stoving temperatures than is the case for conventional blocked polyisocyanates.

The invention is further illustrated but is not intended to be limited by the following examples in which all parts and percentages are by weight unless otherwise specified.

### EXAMPLES

In the Examples which follow, all percentages are wt. %, unless indicated otherwise. The indicated solids contents of the products are calculated values corresponding to the portion of the components not used as solvent.

Room temperature is understood to mean 23±3° C.

Starting Materials:

Polyisocyanate 1

Isocyanurate-group-containing polyisocyanate based on HDI having an NCO content (based on NCO, molecular weight=42) of 21.7 wt. %, having a mean isocyanate functionality of 3.4 (according to GPC) and a content of monomeric HDI of 0.1%.

Polyisocyanate 2

70% solution of an isocyanurate-group-containing polyisocyanate based on IPDI in Solvesso® 100, having an NCO content (based on NCO, molecular weight=42) of 11.8 wt. %, having a mean isocyanate functionality of 3.3 (according to GPC) and a content of monomeric IPDI of 0.1%.

Polyisocyanate 3

Iminooxadiazinedione-group-containing polyisocyanate based on HDI having an NCO content (based on NCO, molecular weight=42) of 23.2 wt. %, having a mean isocyanate functionality of 3.3 (according to GPC) and a content of monomeric HDI of 0.1%, prepared according to EP 798299.

Fatty alcohol (see Examples 1, 2, 4, 6, 8 according to the invention) Commercial fatty alcohol; trade name: Lorol®, Henkel KGaA, Düsseldorf; characteristic values: acid number <1; saponification number <1.2; hydroxyl number 265-279; water content <0.2%; chain distribution: <C12: 0-3%, C12: 48-58%, C14: 18-24%, C16: 8-12%, C18: 11-15%, <C18: 0-1%.

### EXAMPLE 1

### According to the Invention

Allophanate-Group-Containing Polyisocyanate, Diisopropylamine-Blocked

51.0 g of fatty alcohol were added, with stirring and under dry nitrogen, to 919.1 g of polyisocyanate 1, and heating was carried out at 80° C. until the titrimetrically determined NCO value of 19.5% had been reached. 0.2 g of zinc(II) 2-ethyl-1-hexanoate was then added. The allophanate-formation reaction was started by the addition of the zinc compound. The mixture was heated to 110° C. and stirred at that temperature until the NCO value of 18.4% corresponding to complete allophanate formation had been reached. The reaction was terminated by cooling to room temperature, and the reaction mixture was then diluted with 377 g of methoxypropyl acetate (MPA). 429.3 g of diisopropylamine were added, whereupon a slight exothermic reaction was observed, and, when the addition was complete, the mixture was heated to 70° C. After 30 minutes' stirring at that temperature, the batch was cooled to room temperature. No further free isocyanate groups were detectable in the IR spectrum after that time. Dilution was then carried out with a further 377 g of isobutanol, yielding a clear, almost colourless product having the following characteristic data.

Content of blocked NCO groups (molecular weight=42): 8.3%

NCO functionality (according to formula [2]): 3.71

Solids content: 65%

Viscosity: 2900 mPas

Degree of conversion to allophanate: x=1

Proportion of covalently bonded alkoxy groups: 5.26%

After 3 months' storage of the product at room temperature, neither turbidity of the solution nor any kind of solids precipitation or crystallisation was to be observed.

### EXAMPLE 2

### According to the Invention

Allophanate-Group-Containing Polyisocyanate, Diisopropylamine-Blocked

9.0 g of 1,3-butanediol and 30.6 g of fatty alcohol were added, with stirring and under dry nitrogen, to 919.1 g of polyisocyanate 1, and heating was carried out at 80° C. until the titrimetrically determined NCO value of 19.7% had been reached. 0.2 g of zinc(II) 2-ethyl-1-hexanoate was then added. The allophanate-forming reaction was started by the addition of the zinc compound. The mixture was heated to 110° C. and stirred at that temperature until the NCO value of 18.6% corresponding to complete allophanate formation had been reached. The reaction was terminated by the addition of 0.2 g of dibutyl phosphate and cooling to room temperature, and the reaction mixture was then diluted with 372 g of methoxy-propyl acetate (MPA). 429.3 g of diisopropylamine were added, whereupon a slight exothermic reaction was observed, and, when the addition was complete, the mixture was heated to 70° C. After 30 minutes' stirring at that temperature, the batch was cooled to room temperature. No further free isocyanate groups were detectable in the IR spectrum after that time. Dilution was then carried out with a further 373 g of isobutanol, yielding a clear, almost colourless product having the following characteristic data.

Content of blocked NCO groups (molecular weight=42): 8.4%

NCO functionality (according to formula [2]): 3.87

Solids content: 65%

Viscosity: 3800 mPas

Degree of conversion to allophanate: x=1

Proportion of covalently bonded alkoxy groups: 4.10%

After 3 months' storage of the product at room temperature, neither turbidity of the solution nor any kind of solids precipitation or crystallisation was to be observed.

### EXAMPLE 3

### According to the Invention

Allophanate-Group-Containing Polyisocyanate, Diisopropylamine-Blocked

92.50 g of n-butanol and 0.4 g of zinc(II) 2-ethyl-1-hexanoate were added, with stirring and under dry nitrogen, to 1688.8 g of polyisocyanate 1. The mixture was heated to 110° C. and stirred at that temperature until the NCO value of 14.7% corresponding to complete allophanate formation had been reached. The reaction was terminated by cooling to room temperature, and the reaction mixture was then diluted with 649.3 g of methoxypropyl acetate (MPA). 630.0 g of diisopropylamine were added, whereupon a slight exothermic reaction was observed, and, when the addition was complete, the mixture was heated to 70° C. After 30 minutes' stirring at that temperature, the batch was cooled to room temperature.

No further free isocyanate groups were detectable in the IR spectrum after that time. Dilution was then carried out with a further 649.3 g of isobutanol, yielding a clear, almost colourless product having the following characteristic data.

Content of blocked NCO groups (molecular weight=42): 7.1%

NCO functionality (according to formula [2]): 4.73

Solids content: 65%

Viscosity: 3500 mPas

Degree of conversion to allophanate: x=1

Proportion of covalently bonded alkoxy groups: 5.19%

After 3 months' storage of the product at room temperature, neither turbidity of the solution nor any kind of solids precipitation or crystallisation was to be observed.

### EXAMPLE 4

### According to the Invention

Allophanate-Group-Containing And Urethane-Group-Containing Polyisocyanate, Diisopropylamine-Blocked

51.0 g of fatty alcohol were added, with stirring and under dry nitrogen, to 919.1 g of polyisocyanate 1, and heating was carried out at 80° C. until the titrimetrically determined NCO value of 19.5% had been reached. 0.2 g of zinc(II) 2-ethyl-1-hexanoate was then added. The allophanate-forming reaction was started by the addition of the zinc compound. The mixture was heated to 110° C. and stirred at that temperature until an NCO value of 19.0% had been reached. The reaction was terminated by cooling to room temperature, and the reaction mixture was then diluted with 381 g of methoxypropyl acetate (MPA). 444.5 g of diisopropylamine were added, whereupon a slight exothermic reaction was observed, and, when the addition was complete, the mixture was heated to 70° C. After 30 minutes' stirring at that temperature, the batch was cooled to room temperature. No further free isocyanate groups were detectable in the IR spectrum after that time. Dilution was then carried out with a further 381 g of isobutanol, yielding a clear, almost colourless product having the following characteristic data.

Content of blocked NCO groups (molecular weight=42): 8.5%

NCO functionality (according to formula [2]): 3.39

Solids content: 65%

Viscosity: 2020 mPas

Degree of conversion to allophanate: x=0.4

Proportion of covalently bonded alkoxy groups: 5.26%

After 3 months' storage of the product at room temperature, neither turbidity of the solution nor any kind of solids precipitation or crystallisation was to be observed.

### EXAMPLE 5

### Comparison

Isocyanurate-Group-Containing Polyisocyanate, Diisopropylamine-Blocked

193.5 g of polyisocyanate 1 were diluted with 79.3 g of methoxypropyl acetate (MPA), and 101.0 g of diisopropylamine were added, with stirring and under dry nitrogen, whereupon a slight exothermic reaction was observed. When the addition was complete, the mixture was heated to 70° C. and, after 30 minutes' stirring at that temperature, the batch was cooled to room temperature. No further free isocyanate groups were then detectable in the IR spectrum. Finally, dilution was carried out with a further 79.3 g of isobutanol, yielding a clear, almost colourless product having the following characteristic data.

Content of blocked isocyanate groups (molecular weight=42): 9.3%

NCO functionality (GPC): 3.4

Solids content: 65%

Viscosity: 2070 mPas

After 14 days' storage at room temperature, solidification by crystallisation began. After 18 days' storage at room temperature, a solid, white, opaque mass had formed.

### EXAMPLE 6

### According to the Invention

Allophanate-Group-Containing And Urethane-Group-Containing Polyisocyanate, Diisopropylamine-Blocked

51.0 g of fatty alcohol were added, with stirring and under dry nitrogen, to 859.8 g of polyisocyanate 3, and heating was carried out at 80° C. until the titrimetrically determined NCO value of 21.8% had been reached. 0.2 g of zinc(II) 2-ethyl-1-hexanoate was then added, whereby the allophanate-forming reaction was started.

The mixture was heated to 110° C. and stirred at that temperature until an NCO value of 19.8% had been reached. The reaction was terminated by cooling to room temperature, and the reaction mixture was diluted with 362 g of methoxypropyl acetate (MPA). 433.8 g of diisopropylamine were added, whereupon a slight exothermic reaction was observed, and, when the addition was complete, the mixture was heated to 70° C. After 30 minutes' stirring at that temperature, the batch was cooled to room temperature. No further free isocyanate groups were detectable in the IR spectrum after that time. Dilution was then carried out with a further 362 g of isobutanol, yielding a clear, almost colourless product having the following characteristic data.

Content of blocked NCO groups (molecular weight=42): 8.7%

NCO functionality (according to formula [2]): 3.47

Solids content: 65%

Viscosity: 2900 mPas

Degree of conversion to allophanate: x=0.8

Proportion of covalently bonded alkoxy groups: 5.60%

After 3 months' storage of the product at room temperature, neither turbidity of the solution nor any kind of solids precipitation or crystallisation was to be observed.

### EXAMPLE 7

### Comparison

Isocyanurate-Group-Containing Polyisocyanate, Diisopropylamine-Blocked

181.0 g of polyisocyanate 3 were diluted with 76.0 g of methoxypropyl acetate (MPA), and 101.0 g of diisopropylamine were added, with stirring and under dry nitrogen, whereupon a slight exothermic reaction was observed. When the addition was complete, the mixture was heated to 70° C. After 30 minutes' stirring at that temperature, the batch was cooled to room temperature. No further free isocyanate groups were detectable in the IR spectrum after that time. Dilution with a further 76.0 g of isobutanol was then carried out, yielding a clear, almost colourless product having the following characteristic data.

Content of blocked isocyanate groups (molecular weight=42): 9.7%

NCO functionality (GPC): 3.3

Solids content: 65%

Viscosity: 1560 mPas

After 14 days' storage at room temperature, solidification by crystallisation began.

After 18 days' storage at room temperature, a solid, white, opaque mass had formed.

### EXAMPLE 8

Allophanate-Group-Containing Polyisocyanate, 1,2,4-triazole-blocked

102.0 g of fatty alcohol were added, with stirring and under dry nitrogen, to 871.0 g of polyisocyanate 1, and heating was carried out at 80° C. until the titrimetrically determined NCO value of 17.3% had been reached. 0.2 g of zinc(II) 2-ethyl-1-hexanoate was then added, whereby the allophanate-forming reaction was started. The mixture was heated to 110° C. and stirred at that temperature until the NCO value of 15.1% corresponding to complete allophanate formation had been reached. The reaction was terminated by cooling to room temperature, and the reaction mixture was then diluted with 404.8 g of methoxypropyl acetate (MPA). 241.5 g of 1,2,4-triazole were then added and, when the addition was complete, the mixture was heated to 90° C. After 60 minutes' stirring at that temperature, the batch was cooled to room temperature. No further free isocyanate groups were detectable in the IR spectrum after that time. Dilution was then carried out with a further 404.8 g of Solvesso® 100 (Exxon Chemicals, Houston, USA), yielding a cloudy, light-yellow product having a marked crystalline solids content, which increased markedly in the course of 3 days during storage.

Content of blocked NCO groups (molecular weight 42): 7.3%

NCO functionality (according to formula [2]): 4.00

Solids content: 60%

Degree of conversion to allophanate: x=1

Proportion of covalently bonded alkoxy groups: 10.50%

It is clear that allophanate-group-containing polyisocyanates in conjunction with 1,2,4-triazole do not result in products that are stable to crystallisation.

### EXAMPLE 9

Production and Testing of the Properties of Lacquers Based on some Polyisocyanates Described in the Examples (According to the Invention and Comparison)

On the basis of the polyisocyanate crosslinkers described in the Examples and the hydroxy-functional polyacrylate polyol Desmophen® A 870 BA (70% solution in butyl acetate, 1 gram equivalent=575 g) from Bayer AG, Leverkusen, clear lacquers having an NCO/OH equivalent ratio of 1.00 were produced, which clear lacquers contained as catalyst 1% dibutyltin dilaurate, based on the sum of the solids contents of the crosslinker and of the polyol. The lacquers also contained as flow improvers 0.01% Modaflow (acrylic copolymer from Solutia) and 0.1% Baysilon OL 17 (polyether polysiloxane from Bayer AG, Leverkusen), based on the sum of the solids content of the crosslinker and of the polyol. The lacquers were adjusted to a solids content of 45% by dilution with a 1:1 mixture of methoxypropyl acetate (MPA) and Solvesso® 100 and applied to glass plates by means of a knife. After being exposed to the air for 10 minutes and stoved for 30 minutes in an air-circulating oven at the temperatures indicated below, coated glass plates having a dry film layer thickness of 40 μm were obtained. The following tables show the Konig pendulum damping of the lacquer films so obtained.

TABLE 1
König pendulum damping in dependence on the stoving
temperature

| | Example 1 | Example 3 | |
|---|---|---|---|
| | (according to the | (according to the | Example 5 |
| Temperature | invention) | invention) | (comparison) |
| 110° C. | 155 | 149 | 129 |
| 120° C. | 183 | 175 | 170 |
| 130° C. | 183 | 174 | 218 |
| 140° C. | — | — | 217 |

It is clear that the lacquer film based on the diisopropylamine-blocked polyisocyanate according to the invention achieves its highest pendulum damping at a stoving temperature of only 120° C., while the lacquer film based on the corresponding polyisocyanate from the comparison example does not achieve its highest pendulum damping until 130° C.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Polyisocyanates which
A) have a mean NCO functionality ≧2,
B) have a content of blocked NCO groups (calculated as NCO, molecular weight=42) of from 2.0 to 17.0 wt. %,
C) have a content of from 1 to 30 wt. % alkoxy groups as a constituent of allophanate and, optionally, urethane groups, the molar ratio of allophanate groups to urethane groups being at least 1:9, and
D) optionally contain auxiliary substances or additives,
wherein at least 95 mol. % of the free NCO groups are blocked with a blocking agent of the formula R¹R²NH, in which R¹ and R² are each independently of the other aliphatic or cycloaliphatic C₁-C₁₂-alkyl radicals.

2. The polyisocyanates according to claim 1, wherein the polyisocyanates are based on aliphatic and/or cycloaliphatic diisocyanates.

3. The polyisocyanates according to claim 1, wherein the molar ratio of allophanate groups to urethane groups is at least 3:7.

4. A process for the preparation of the polyisocyanates according to claim 1 comprising reacting
a) at least one polyisocyanate having a mean NCO functionality ≧2 and an NCO content (calculated as NCO; molecular weight=42) of from 8.0 to 27.0 wt. %, with
b) at least one alcohol to form urethane groups and
c) optionally with the addition of at least one catalyst, such a proportion of the urethane groups is converted to allophanate groups that the molar ratio of allophanate groups to urethane groups is at least 1:9, and the remaining isocyanate groups, which is then reacted with
d) a blocking agent of the formula R¹R²NH, in which R¹ and R² are each independently of the other aliphatic or cycloaliphatic C₁-C₁₂-alkyl radicals, so that at least 95 mol. % of the isocyanate groups are in blocked form.

5. The process according to claim 4, wherein such a proportion of the urethane groups are converted to allophanate groups that the molar ratio of allophanate groups to urethane groups is at least 3:7.

6. A method of making polyurethane materials and coatings comprising mixing the polyisocyanate of claim 1 with constituents for making the polyurethane materials and coatings.

7. Substrates coated with coatings according to claims 6.

8. A method of making polyurethane materials and coatings comprising mixing the polyisocyanate of claim 2 with constituents for making the polyurethane materials and coatings.

9. Substrates coated with coatings according to claims 8.

10. A method of making polyurethane materials and coatings comprising mixing the polyisocyanate of claim 3 with constituents for making the polyurethane materials and coatings.

11. Substrates coated with coatings according to claims 10.
